(19) United States
(12) Patent Application Publication
(10) Pub. No.: US 2026/0366329 A1
(43) Pub. Date: Nov. 19, 2026

(54) Door Locking System for Integration in New Construction

(71) Applicant: Willo Products Company, LLC, Decatur, AL (US)

(72) Inventors: Brian S. Foss, Madison, AL (US); Kanzaz Bailey, Athens, AL (US)

(21) Appl. No.: 19/644,483

(22) Filed: Apr. 10, 2026

Related U.S. Application Data
(60) Provisional application No. 63/795,920, filed on Apr. 28, 2025.

(51) Int. Cl. E05B 9/08

(52) U.S. Cl. CPC E05B 9/08

(57) ABSTRACT

A lock system includes a housing, a primary bracket, and a secondary bracket. The housing includes a front portion and a rear portion coupled to the front portion. The primary bracket includes a first base portion, a first tab portion, and a second tab portion. At least one of the first tab portion or the second tab portion is coupled to the rear portion. The rear portion and the primary bracket define a first cavity. The secondary bracket is disposed in the first cavity and engages the first base portion and the rear portion.

### CROSS-REFERENCE TO RELATED APPLICATIONS

This application claims the benefit of U.S. Provisional Application No. 63/795,920, filed Apr. 28, 2025, the entire disclosure of which is incorporated by reference.

### FILED

The present disclosure relates to a door locking system for integration in new construction, and more particularly to a door locking assembly configured for integration into a void formed in a door or door frame.

### BACKGROUND

Doors and door frames used in prisons and various other properties and facilities are often retrofitted with systems that allow authorized individuals to access a room (e.g., a prison cell) on the interior side of a door and prevent unauthorized individuals from opening the door and exiting the room. Retrofitting a prison door or door frame with such a system can be time-consuming, expensive, and result in a system that occupies more space on the exterior of the door or door frame than might otherwise be preferred.

While known systems and methods for constructing doors and/or door frames with integrated locking systems have proven acceptable for their intended purposes, there exists a continuous need for improvement in the pertinent art.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the disclosure provides a lock system for assembly within a door frame. The lock system includes a housing, a primary bracket, and a secondary bracket. The housing includes a front portion and a rear portion coupled to the front portion. The primary bracket includes a first base portion, a first tab portion, and a second tab portion. At least one of the first tab portion or the second tab portion is coupled to the rear portion. The rear portion and the primary bracket define a first cavity. The secondary bracket is disposed in the first cavity and engages the first base portion and the rear portion.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a perspective view of a door locking system according to the principles of the present disclosure.

FIG. 2 is a perspective view of a lock system of the door locking system of FIG. 1 according to the principles of the present disclosure.

FIG. 3 is a side view of the lock system of FIG. 2.

FIG. 4 is a top view of the lock system of FIG. 2.

In the drawings, reference numbers may be reused to identify similar and/or identical elements.

### DETAILED DESCRIPTION

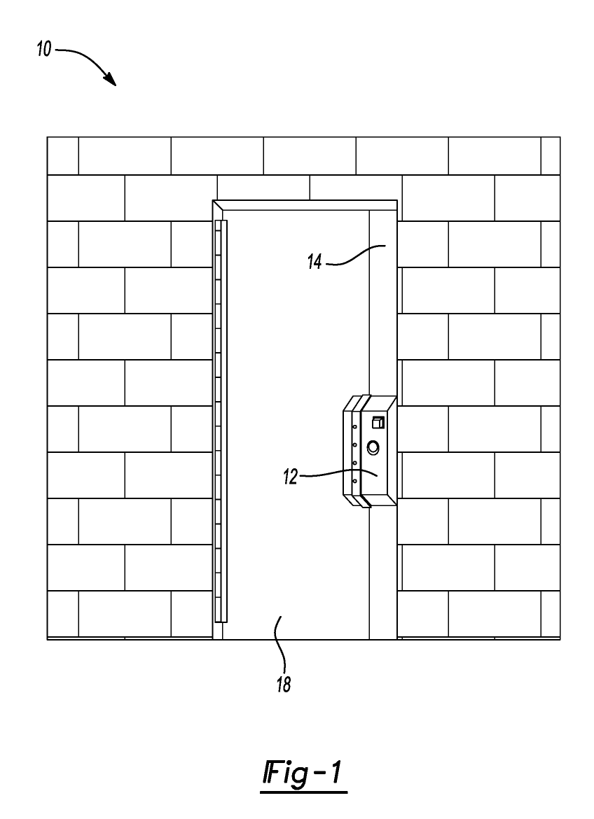

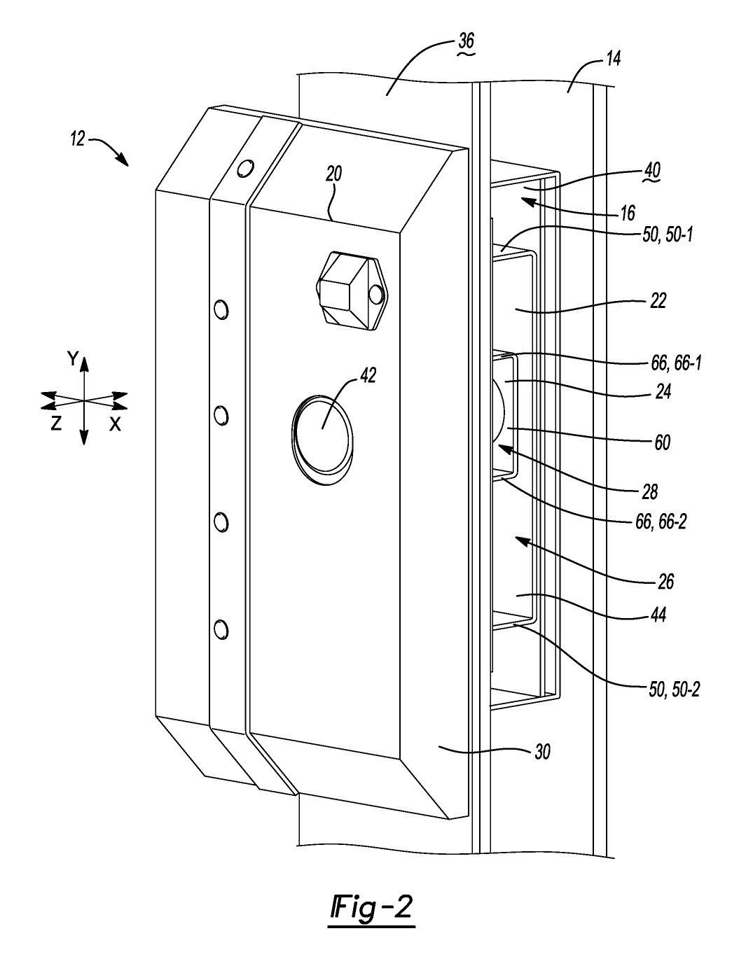

Referring now to FIG. 1, a door locking system 10 is illustrated. The door locking system 10 may include a lock system 12 and a door frame 14. The lock system 12 may be mounted on or within the door frame 14. In various implementations, the lock system 12 is disposed at least partially within a first cavity 16 (FIG. 2) of the door frame 14. As will be explained in more detail below, the door locking system 10 may secure a door 18 in a closed orientation (FIG. 1) relative to the door frame 14 to inhibit passage into or out of a room (not shown) on one side of the door 18. While the lock system 12 is shown and described herein as being mounted on or within the door frame 14, the lock system 12 may be mounted on or within the door 18 within the scope of the present disclosure.

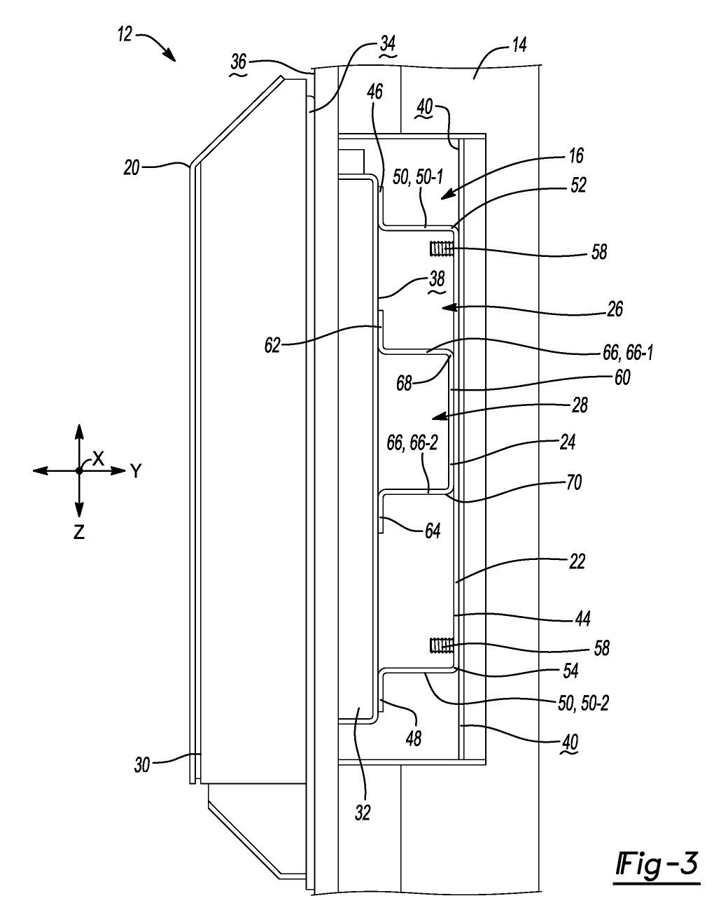

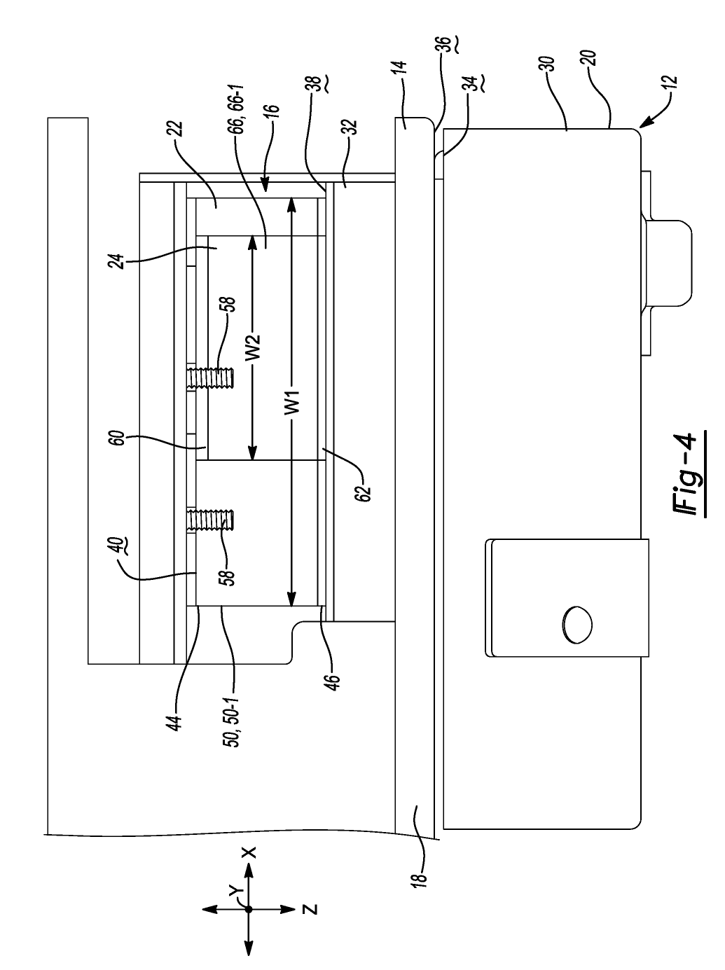

Referring now to FIGS. 2, 3, and 4, the lock system 12 may include a housing 20, a primary bracket 22, and a secondary bracket 24. In various implementations, the housing 20, the primary bracket 22, and the secondary bracket 24 are at least partially disposed within the first cavity 16. The housing 20, the primary bracket 22, and the secondary bracket 24 may be coupled to one another. In various implementations, the primary bracket 22 is coupled to the housing 20, such that the primary bracket 22 and the housing 20 at least partially define a second cavity 26 therebetween. In various implementations, the secondary bracket 24 is coupled to the housing 20, such that the secondary bracket 24 and the housing 20 at least partially define a third cavity 28 therebetween. The secondary bracket 24 may be disposed between and coupled to the primary bracket 22 and the housing 20.

The housing 20 may include a front portion 30 and a rear portion 32. The front portion 30 may be coupled to the rear portion 32. In various implementations, the front portion 30 is larger than the rear portion 32. For example, the front portion 30 may have a length and/or width that is greater than a length and/or width of the rear portion 32. In this regard, the front portion 30 may define a first cross-sectional area that is larger than a second cross-sectional area of the rear portion 32.

The front portion 30 may include a first surface 34. In an assembled configuration (FIG. 2), the first surface 34 may engage an exterior surface 36 of the door frame 14. In various implementations, the front portion 30 may cover (e.g., partially or completely cover) the first cavity 16 in the assembled configuration (FIG. 2). In this regard, the cross-sectional area of the front portion 30 may be larger than a cross-sectional area of the first cavity 16.

In the assembled configuration (FIG. 2), the rear portion 32 may be disposed within the first cavity 16. In various implementations, the rear portion 32 includes a second surface 38. The second surface 38 may be offset from and face an interior surface 40 of the door frame 14 in the assembled configuration (FIG. 2). The second surface 38 may be substantially (e.g., +/- 10 degrees) parallel to the interior surface 40.

In various implementations, the housing 20 may include a lock mechanism 42. The lock mechanism 42 may be disposed within and supported by the housing 20. For example, the lock mechanism 42 may be disposed within and supported by the front portion 30. The lock mechanism 42 may engage or be disposed within a corresponding feature or aperture (not shown) of the door 18 to secure the door 18 in a closed orientation (FIG. 1) relative to the door frame 14.

The primary bracket 22 may include a first base portion 44, a first tab portion 46, and a second tab portion 48. The first tab portion 46 and the second tab portion 48 may be connected to the first base portion 44 by one or more legs 50. For example, a first leg 50-1 may extend from a first end 52 of the first base portion 44 and connect to the first tab portion 46, and a second leg 50-2 may extend from a second end 54 of the first base portion 44 and connect to the second tab portion 48. In various implementations, the first tab portion 46 extends in a first direction (e.g., Y-direction), the second tab portion 48 extends in a second direction (e.g., Y-direction), the first base portion 44 extends in a third direction (e.g., Y-direction), and the first, second, and third directions are substantially (e.g., +/- 10 degrees) parallel to one another. In various implementations, the primary bracket 22 defines a first width W1 (e.g., in the X-direction).

In the assembled configuration (FIG. 2), at least one of the first tab portion 46 or the second tab portion 48 may be coupled to the rear portion 32 of the housing 20. In various implementations, both the first tab portion 46 and the second tab portion 48 are coupled to the rear portion 32 of the housing 20. In the assembled configuration (FIG. 2), the first base portion 44 may be coupled to the door frame 14. For example, the first base portion 44 may be coupled to the interior surface 40 of the door frame 14. The first base portion 44 may be coupled to the door frame 14 by one or more fasteners 58. For example, the one or more fasteners 58 may be nails, screws, bolts and nuts, pins, rivets, glue, adhesives, tape, or any other fastener within the scope of the present disclosure.

The secondary bracket 24 may include a second base portion 60, a third tab portion 62, and a fourth tab portion 64. The third tab portion 62 and the fourth tab portion 64 may be connected to the second base portion 60 by one or more legs 66. For example, a first leg 66-1 may extend from a first end 68 of the second base portion 60 and connect to the third tab portion 62, and a second leg 66-2 may extend from a second end 70 of the second base portion 60 and connect to the fourth tab portion 64. In various implementations, the third tab portion 62 extends in a fourth direction (e.g., Y-direction), the fourth tab portion 64 extends in a fifth direction (e.g., Y-direction), the second base portion 60 extends in a sixth direction (e.g., Y-direction), and the fourth, fifth, and sixth directions are substantially (e.g., +/- 10 degrees) parallel to one another. In various implementations, all of the first, second, third, fourth, fifth, and sixth directions are substantially (e.g., +/- 10 degrees) parallel to one another. In various implementations, the secondary bracket 24 defines a second width W2 (e.g., in the X-direction). The second width W2 may be smaller than the first width W1.

In the assembled configuration (FIG. 2), at least one of the third tab portion 62 or the fourth tab portion 64 may be coupled to the rear portion 32 of the housing 20. In various implementations, both the third tab portion 62 and the fourth tab portion 64 are coupled to the rear portion 32 of the housing 20. In the assembled configuration (FIG. 2), the second base portion 60 may be coupled to the first base portion 44. In various implementations, the second base portion 60 is coupled to the first base portion 44 by one or more fasteners. For example, the one or more fasteners may be nails, screws, bolts and nuts, pins, rivets, glue, adhesives, tape, or any other fastener within the scope of the present disclosure.

The above description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Unless indicated otherwise, numbering or other labeling of instructions or method steps is done for convenient reference, not to indicate a fixed order.

Numerical terms, such as “first,” “second,” and “third,” may be used in the disclosure and claims as unique labels: they are not used to imply a sequence or order unless the context clearly indicates otherwise. In other words, a “second” element could be relabeled as a “first” element without departing from the principles of the present disclosure. Further, the presence of a “second” element does not imply or require the presence of a “first” element. Similarly, the presence of a “first” element does not imply or require the presence of a “second” element.

Unless the context clearly indicates otherwise, the singular articles “a,” “an,” and “the” before a noun do not restrict the noun to a single instance. The verbs “comprise,” “include,” and “have” are inclusive and therefore specify the presence of elements without excluding the presence of one or more additional elements.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements are described using various terms, including “connected,” “coupled,” “engaged,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

The term “set” generally means a grouping of one or more elements. The elements of a set do not necessarily need to have any characteristics in common or otherwise belong together. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set — that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR. The phrase "A, B, and/or C" should be construed in the same way as the phrase “at least one of A, B, and C.”

Various example embodiments of the invention are described in the following clauses.

Clause 1: A lock system for assembly within a door frame, the lock system comprising: a housing including a front portion and a rear portion coupled to the front portion; a primary bracket defining a first cavity and including a first base portion, a first tab portion, and a second tab portion, at least one of the first tab portion or the second tab portion coupled to the rear portion; and a secondary bracket disposed in the first cavity and engaging the first base portion and the rear portion.

Clause 2: The lock system of clause 1, wherein the first tab portion and the second tab portion are coupled to the rear portion.

Clause 3: The lock system of clause 2, wherein: the first tab portion extends in a first direction, the second tab portion extends in a second direction, the first base portion extends in a third direction, and the first direction, the second direction, and the third direction are substantially parallel to one another.

Clause 4: The lock system of clause 3, wherein: the secondary bracket includes a second base portion, a third tab portion, and a fourth tab portion, the second base portion is coupled to the first base portion, and at least one of the third tab portion or the fourth tab portion is coupled to the rear portion.

Clause 5: The lock system of clause 4, wherein the third tab portion and the fourth tab portion are coupled to the rear portion.

Clause 6: The lock system of clause 5, wherein: the third tab portion extends in a fourth direction, the fourth tab portion extends in a fifth direction, the second base portion extends in a sixth direction, and the fourth direction, the fifth direction, and the sixth direction are substantially parallel to one another.

Clause 7: The lock system of clause 6, wherein the first direction, the second direction, the third direction, the fourth direction, the fifth direction, and the sixth direction are substantially parallel to one another.

Clause 8: The lock system of any of clauses 1–7, wherein the secondary bracket defines a second cavity.

Clause 9: The lock system of any of clauses 1–8, further comprising a lock mechanism disposed within and supported by the front portion.

Clause 10: The lock system of any of clauses 1–9, wherein a first cross-sectional area of the front portion is larger than a second cross-sectional area of the rear portion.

Clause 11: The lock system of any of clauses 1–10, wherein the secondary bracket is disposed between the primary bracket and the housing.

Clause 12: The lock system of any of clauses 1–11, further comprising a set of fasteners configured to couple the first base portion to an interior surface of a door frame.

Clause 13: The lock system of clause 12, wherein the set of fasteners is configured to couple a second base portion of the secondary bracket to the first base portion.

Clause 14: The lock system of any of clauses 1–13, wherein: the primary bracket defines a first width, the secondary bracket defines a second width, and the second width is smaller than the first width.

Clause 15: A door locking system comprising: the lock system of any of clauses 1–14; and a door frame defining a third cavity, the lock system at least partially disposed within the third cavity.

Clause 16: The door locking system of clause 15, wherein the rear portion is disposed in the third cavity.

Clause 17: The door locking system of any of clauses 15–16, wherein: the front portion of the housing includes a first surface, the door frame includes an exterior surface, and the first surface engages the exterior surface.

Clause 18: The door locking system of any of clauses 15–17, wherein the first base portion is coupled to the door frame.

Clause 19: The door locking system of any of clauses 15–18, wherein the first base portion is coupled to an interior surface of the door frame by one or more fasteners.

Clause 20: The door locking system of any of clauses 15–19, wherein a cross-sectional area of the front portion of the housing is larger than a third cross-sectional area of the third cavity.

1. A lock system for assembly within a door frame, the lock system comprising:
a housing including a front portion and a rear portion coupled to the front portion;
a primary bracket defining a first cavity and including a first base portion, a first tab portion, and a second tab portion, at least one of the first tab portion or the second tab portion coupled to the rear portion; and
a secondary bracket disposed in the first cavity and engaging the first base portion and the rear portion.

2. The lock system of claim 1, wherein the first tab portion and the second tab portion are coupled to the rear portion.

3. The lock system of claim 2, wherein:
the first tab portion extends in a first direction,
the second tab portion extends in a second direction,
the first base portion extends in a third direction, and
the first direction, the second direction, and the third direction are substantially parallel to one another.

4. The lock system of claim 3, wherein:
the secondary bracket includes a second base portion, a third tab portion, and a fourth tab portion,
the second base portion is coupled to the first base portion, and
at least one of the third tab portion or the fourth tab portion is coupled to the rear portion.

5. The lock system of claim 4, wherein the third tab portion and the fourth tab portion are coupled to the rear portion.

6. The lock system of claim 5, wherein:
the third tab portion extends in a fourth direction,
the fourth tab portion extends in a fifth direction,
the second base portion extends in a sixth direction, and
the fourth direction, the fifth direction, and the sixth direction are substantially parallel to one another.

7. The lock system of claim 6, wherein the first direction, the second direction, the third direction, the fourth direction, the fifth direction, and the sixth direction are substantially parallel to one another.

8. The lock system of claim 1, wherein the secondary bracket defines a second cavity.

9. The lock system of claim 1, further comprising a lock mechanism disposed within and supported by the front portion.

10. The lock system of claim 1, wherein a first cross-sectional area of the front portion is larger than a second cross-sectional area of the rear portion.

11. The lock system of claim 1, wherein the secondary bracket is disposed between the primary bracket and the housing.

12. The lock system of claim 1, further comprising a set of fasteners configured to couple the first base portion to an interior surface of a door frame.

13. The lock system of claim 12, wherein the set of fasteners is configured to couple a second base portion of the secondary bracket to the first base portion.

14. The lock system of claim 1, wherein:
the primary bracket defines a first width,
the secondary bracket defines a second width, and
the second width is smaller than the first width.

15. A door locking system comprising:
the lock system of claim 1; and
a door frame defining a third cavity, the lock system at least partially disposed within the third cavity.

16. The door locking system of claim 15, wherein the rear portion is disposed in the third cavity.

17. The door locking system of claim 16, wherein:
the front portion of the housing includes a first surface,
the door frame includes an exterior surface, and
the first surface engages the exterior surface.

18. The door locking system of claim 17, wherein the first base portion is coupled to the door frame.

19. The door locking system of claim 18, wherein the first base portion is coupled to an interior surface of the door frame by one or more fasteners.

20. The door locking system of claim 19, wherein a cross-sectional area of the front portion of the housing is larger than a third cross-sectional area of the third cavity.
